(19) United States
(12) Patent Application Publication
(10) Pub. No.: US 2004/0042766 A1
(43) Pub. Date: Mar. 4, 2004

(54) Information reproducing apparatus and method

(75) Inventor: Takehiko Mizushiri, Kawagoe-shi (JP)

Correspondence Address: YOUNG & THOMPSON, 745 SOUTH 23RD STREET 2ND FLOOR, ARLINGTON, VA, 22202

(73) Assignees: PIONEER CORPORATION, TOKYO (JP); PIONEER SYSTEM TECHNOLOGIES CORPORATION, SENDAI-SHI (JP)

(21) Appl. No.: 10/650,798

(22) Filed: Aug. 29, 2003

(30) Foreign Application Priority Data
Aug. 30, 2002 (JP) 2002-252805

(51) Int. Cl. H04N 5/76; H04N 5/781

(52) U.S. Cl. 386/96; 386/98

(57) ABSTRACT

An information reproducing apparatus for reproducing audio information and multiple still picture information units in a slide show reproduction. If a command to select a still picture from among multiple still pictures, a reproduction position is determined on the basis of a reproduction start time point of a still picture information unit corresponding to the selected still picture, and then the audio information and the selected still picture is immediately reproduced from the determined reproduction position.

### BACKGROUND OF THE INVENTION

1. Field of the invention

The present invention relates to an information reproducing method and apparatus, such as a DVD audio player, for reproducing audio information together with still picture information.

2. Description of the Related Art

Some information reproducing apparatuses such as DVD audio players have a function to reproduce a still picture in addition to sound. Specifically, audio information, multiple units of still picture information corresponding to multiple still pictures (hereinafter referred to as “still picture information units”) and reproduction control information for indicating reproduction start time points for respective still picture information units during reproduction of the audio information are recorded into a recording medium such as a DVD. Thereby, when the recording medium is reproduced by means of the information reproducing apparatus, the still picture information units are reproduced while the audio information is reproduced.

There are various ways of reproducing the still pictures. As an example, there is a way of reproducing still pictures one by one at a predetermined time interval during the reproduction of the sound (a slide show reproduction). The reproduction control information includes therein the start time point of each still picture information unit. During the reproduction of the audio information, the information reproducing apparatus reproduces each still picture information unit in succession, on the basis of the reproduction control information. Thereby, the reproduction of the still pictures can be synchronized with the reproduction of the audio information to perform the slide show reproduction.

Incidentally, in the case of a slide show reproduction according to a DVD standard, the reproduction start time point of each still picture information unit is determined by a maker who makes the audio information and the still picture information units, and thereby the user cannot set or change the reproduction time point as desired.

On the other hand, in the case that the still picture information units are reproduced in the slide show reproduction with the audio information, one still picture information unit is not changed to another one unless the reproduction start time point recorded in the reproduction control information arrives. Therefore, to watch the still picture to be reproduced after the currently reproduced still picture, the user have to wait for a while until the reproduction start time point of the still picture information unit corresponding to the desired still picture arrives. Further in this case, the user cannot watch back the still picture reproduced before the currently reproduced still picture. Still further in this case, the user cannot reproduce multiple still pictures of desired combination.

If the user performs some manipulation to fast-forward or fast-reverse the sound reproduction, however, the user may watch the precedent or next still picture. In spite of this, it is not easy to search promptly a position at which the desired still picture is reproduced, by the fast-forward or fast-reverse operation of the sound reproduction.

### SUMMARY OF THE INVENTION

The present invention has been accomplished in view of the above problems for example. It is therefore an object of the present invention to provide an information reproducing apparatus and method allowing the user to select the still picture to be reproduced with the audio information in the slide show reproduction.

The above object of the present invention can be achieved by an information reproducing apparatus for reproducing audio information and a plurality of still picture information units on the basis of reproduction control information for indicating reproduction time points of the respective plurality of still picture information during a reproduction of the audio information. The information reproducing apparatus is provided with: an audio reproducing device for reproducing the audio information; a still picture reproducing device for reproducing the plurality of still picture information units in sequence by switching the plurality of still picture information units one after another according to the reproduction time points; a selecting device for selecting a still picture information unit among the plurality of still picture information units; and a controlling device for controlling the audio reproducing device and the still picture reproducing device so as to reproduce the audio information and the selected still picture information unit from a reproduction position corresponding to a reproduction time point of the selected still picture information unit.

The above object of the present invention can be achieved by a computer program product in a computer-readable medium for tangibly embodying a program of instructions executable by a computer to make the computer function as the above-mentioned information reproducing apparatus.

The above object of the present invention can be achieved by an information reproducing method of reproducing audio information and a plurality of still picture information units on the basis of reproduction control information for indicating reproduction time points of the respective plurality of still picture information during a reproduction of the audio information. The information reproducing method is provided with: an audio reproducing process of reproducing the audio information; a still picture reproducing process of reproducing the plurality of still picture information units in sequence by switching the plurality of still picture information units one after another according to the reproduction time points; a selecting process of selecting a still picture information unit among the plurality of still picture information units; and a controlling process of controlling the reproduction of the audio information in the audio reproducing process and the reproduction of the plurality of still picture information units in the still picture reproducing process so as to reproduce the audio information and the selected still picture information unit from a reproduction position corresponding to a reproduction time point of the selected still picture information unit.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram illustrating a construction of an information reproducing apparatus according to an embodiment of the present invention.

FIG. 2 is an explanation view illustrating temporal relationship between reproduction of audio information and reproduction of still picture information units.

FIG. 3 is an explanation view illustrating a condition that one still picture information unit is selected.

FIG. 4 is an explanation view illustrating a condition that another still picture information unit is selected.

FIG. 5 is a block diagram illustrating a construction of a DVD audio player according to an Example of the present invention.

FIG. 6 is a plan view illustrating a remote controller of the DVD audio player according to the Example.

FIG. 7 is an explanation view showing display list information.

FIG. 8 is an explanation view illustrating temporal relationship between reproduction of audio information and reproduction of still picture information units.

FIG. 9 is a flow chart showing a processing of selecting a still picture.

### DETAILED DESCRIPTION OF THE PREFERRED EMBODIMENTS

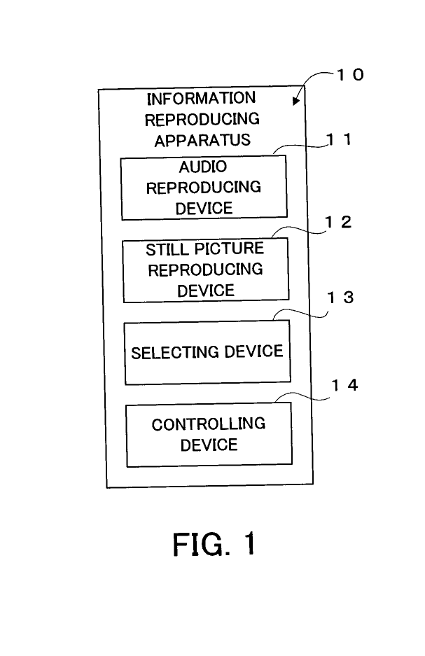

The embodiments of the present invention will now be discussed, referring to FIG. 1 to FIG. 4.

The construction of an information reproducing apparatus according to an embodiment of the present invention will now be discussed.

FIG. 1 shows an information reproducing apparatus according to an embodiment of the present invention. As shown in FIG. 1, the information reproducing apparatus 10 according to the embodiment is an information reproducing apparatus for reproducing audio information and a plurality of still picture information units on the basis of reproduction control information for indicating reproduction time points (playback time points) of the respective plurality of still picture information during a reproduction of the audio information.

The information reproducing apparatus 10 may be a DVD audio player, a DVD karaoke player or the like, for example. Incidentally, the information reproducing apparatus 10 may be a type of information reproducing apparatus for reproducing audio information or still picture information recorded in a recording medium, or may be a type of information reproducing apparatus for reproducing audio information or still picture information delivered via Internet or the like.

The audio information is that which sound such as music is transformed into a kind of signal or data. The still picture information is that which a still picture is transformed into a kind of signal or data. Relating to this, the simplest construction is in the case of one-to-one correspondence between one still picture information unit and one still picture. Nevertheless, this construction is not restrictive.

The reproduction control information is information to indicate each reproduction time point for each of multiple still picture information units during the reproduction of the audio information. The reproduction time point of the still picture information means a time point during a period that the still picture information is reproduced. Incidentally, according to a DVD standard, a reproduction start time point of the still picture information is recorded as reproduction control information, the reproduction time point to be recorded as the reproduction control information is not limited to the reproduction start time point, and may be any time point that indicates a time point during the period that a still picture information unit is reproduced.

Furthermore, a way of indicating the reproduction time point of the still picture information unit may be various. For example, a way of recording a time period from a reproduction start time point of audio information to the reproduction time point of the still picture information, a way of recording a reproduction order (sequence) of multiple still picture information units and a display period of each still picture information unit. Insofar as the reproduction time point of each still picture information unit during the reproduction of audio information can be identified, any way is applicable.

Incidentally, in the case of a slide show according to the DVD standard, the reproduction time point (reproduction start time point) for each still picture information unit in the reproduction control information is fixed. That is, how to set the reproduction time point of each still picture information unit in the reproduction control information is decided by a maker who produces audio information or still picture information units. Therefore, a user cannot change the setting of the reproduction time point for each still picture information unit.

Further, audio information, still picture information units and reproduction control information may be of recorded in a recording medium such as a DVD, or may be of delivered via Internet or the like.

As shown in FIG. 1, the information reproducing apparatus 10 includes: an audio reproducing device 11 for reproducing the audio information; a still picture reproducing device 12 for reproducing the plurality of still picture information units in sequence by switching the plurality of still picture information units one after another according to the reproduction time points; a selecting device 13 for selecting a still picture information unit among the plurality of still picture information units; and a controlling device 14 for controlling the audio reproducing device and the still picture reproducing device so as to reproduce the audio information and the selected still picture information unit from a reproduction position corresponding to a reproduction time point of the selected still picture information unit.

The audio reproducing device 11 includes a reading device, such as an optical pickup, magnetic head or the like, for reading the audio information from the recording medium, in the case that the audio information for example recorded in the recording medium is reproduced. The audio reproducing device 11 further includes a converting device, such as a decoder or the like, for converting the audio information read from the recording medium into sound signals.

The still picture reproducing device 12 is for tangibly embodying a so-called “slide show reproduction” by reproducing multiple still picture information units sequentially one by one. The still picture reproducing device 12 reproduces each still picture information unit on the basis of the reproduction control information. As mentioned above, the reproduction control information includes the information for indicating the reproduction time point of each still picture information unit during the reproduction of the audio information. The still picture reproducing device 12 identifies the reproduction time point of each still picture information unit on the basis of the reproduction control information, and reproduces each still picture information unit at each reproduction time point. The still picture reproducing device 12 switches the still picture information units to be reproduced one after another at every time when the reproduction time point arrives and thereby reproduces multiple still picture information units sequentially one by one.

The selecting device 13 selects one still picture information unit from among multiple still picture information units. The selecting device 13 includes, for example, a user interface or operating mechanism for the selection of the still picture by a user, and an identifying device for identifying the still picture information corresponding to the still picture selected by the user.

The controlling device 14 identifies, on the basis of the reproduction control information, the reproduction time point of one still picture information unit selected through the selecting device 13. Then, the controlling device 14 controls the audio reproducing device 11 and the still picture reproducing device 12 so as to detect the reproduction position corresponding to the reproduction time point of the selected still picture information unit and reproduce the audio information and the selected still picture information unit from the reproduction position. Thereby, the audio information and the selected still picture information unit are reproduced from the reproduction position corresponding to the reproduction time point of the still picture information unit selected through the selecting device 13. Herein, the reproduction time point of one still picture information unit may be any time point during the period that the one still picture information unit is reproduced.

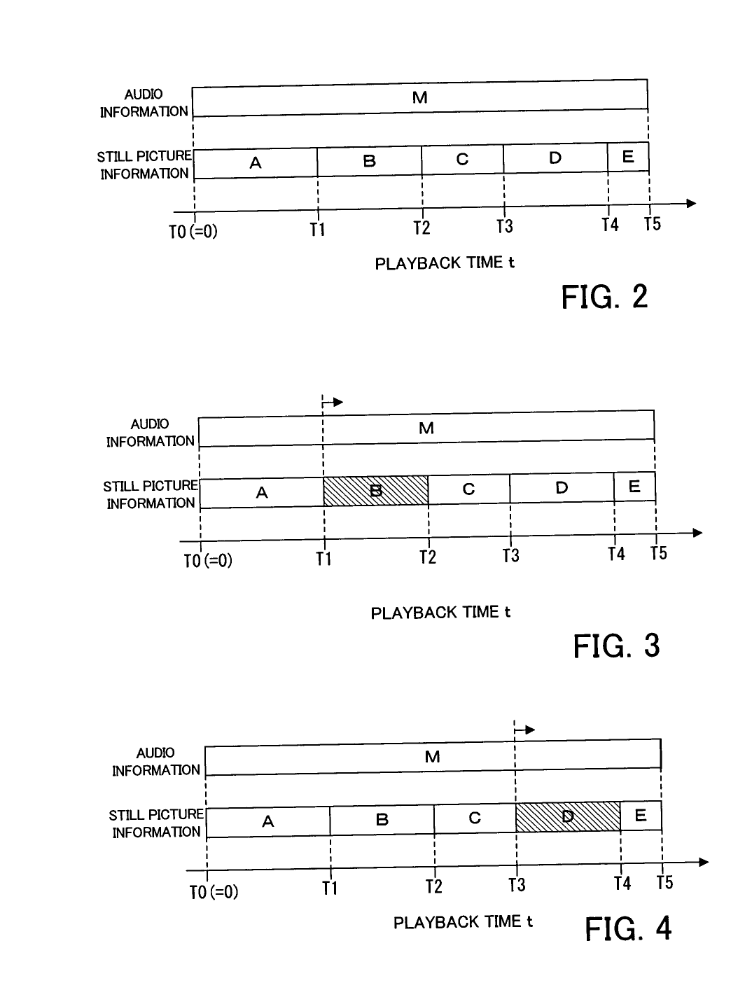

Next, the operation of the information reproducing apparatus 10 will be explained more clearly, referring to FIG. 2 to FIG. 4.

FIG. 2 shows temporal relationship during the reproduction between the audio information M and the still picture information units A to E to be reproduced during the reproduction of the audio information M. That is, a lateral axis in FIG. 2 is representative of the reproduction time t. Then, when the reproduction time t is T0 (T0 is zero in FIG. 2), the reproduction of the audio information M is started, and when the reproduction time t is T5, the reproduction of the audio information M is terminated. On the other hand, when the reproduction time t is T0, the reproduction of the still picture information unit A is started, simultaneously with the start of the reproduction of the audio information M. Then, when the reproduction time t is T1, the still picture information unit to be reproduced is switched from the still picture information unit A to the still picture information unit B. Furthermore, when the reproduction time t is T2, the still picture information unit to be reproduced is switched from the still picture information unit B to the still picture information unit C. Similarly, when the reproduction time t is T3, the still picture information unit to be reproduced is switched from the still picture information unit C to the still picture information unit D, and when the reproduction time t is T4, the still picture information unit to be reproduced is switched from the still picture information unit D to the still picture information unit E. Then, when the reproduction time arrives at T5, the reproduction of the still picture information unit E is terminated, simultaneously with the end of the reproduction of the audio information M.

The following example is discussed about the case that the information reproducing apparatus 10 reads (i) the audio information M, (ii) the still picture information units A to E, and (iii) the reproduction control information to indicate, respectively, the reproduction starting time points T0 to T4 of the still picture information units A to E from a recording medium, such as a DVD or the like, in which these kinds of information are recorded. Further in the following example, the still picture reproducing device 12 switches the still picture information unit on the basis of the reproduction start time point of each still picture information unit, on the other hand, the controlling device 14 controls the audio reproducing device 11 and the still picture reproducing device 12 so as to reproduce the audio information and one still picture information unit selected through the selecting device 13, from the reproduction position corresponding to the reproduction start time point of the one still picture information unit selected through the selecting device. It is noted that these limitations are only for facilitating the understanding about the reproducing operation of the information reproducing apparatus 10.

At first, as shown in FIG. 2, after loading the recording medium into the information reproducing apparatus 10 and the user inputs a command (or instruction) to start the reproduction of information, the audio reproducing device 11 in the information reproducing apparatus 10 starts the reproduction of the audio information M (t=T0=0). At this time, the reproduction start time point of the still picture information unit A is T0, the still picture reproducing device 12 starts the reproduction of the still picture information unit A, on the basis of the reproduction control information. As a result, the reproduction of the audio information M and the reproduction of the still picture information unit A are started at the same time.

Next, if the user inputs a command into the information reproducing apparatus 10 to select a still picture corresponding to the still picture information unit B during the reproduction of the audio information M and the still picture information unit A, then, as shown in FIG. 3, the selecting device 13 receives the user's command and selects the still picture information unit B on the basis of the command. Then, the controlling device 14 identifies the reproduction start time point T1 of the still picture information unit B, on the basis of the reproduction control information, and controls the audio information reproducing device 11 and the still picture reproducing device 12 so as to reproduce the audio information M and the still picture information unit B from the reproduction position corresponding to the reproduction time point T1 of the still picture information unit B. Thereby, the reproduction of the audio information M and the still picture information unit B is immediately started from the reproduction position corresponding to the time point T1.

Next, if the user inputs a command to select a still picture corresponding to the still picture information unit D, during the reproduction of the audio information M and the still picture information unit B, then, as shown in FIG. 4, the selecting device 13 receives the user's command and selects the still picture information unit, on the basis of the command. Then, the controlling device 14 identifies the reproduction start time point T3 of the still picture information unit D on the basis of the reproduction control information and controls the audio reproducing device 11 and the still picture reproducing device 12 so as to reproduce the audio information M and the still picture information unit D from the reproduction position corresponding to the reproduction time point T3 of the still picture information unit D. Thereby, the reproduction of the audio information M and the still picture information unit D is immediately started from the reproduction position corresponding to the time point T3.

Thus, if the user selects any one unit of still picture information from among the still picture information units A to E and inputs a command to select the one still picture information unit during the reproduction of the audio information M and another still picture information unit, the one still picture information unit is immediately reproduced. Then the music information M is reproduced from the reproduction position corresponding to the reproduction start time point of the selected still picture information unit, simultaneously with the start of the reproduction of the one still picture information unit.

Incidentally, the selection of the still picture by the user may be embodied in various modes. For example, it may be embodied in a mode of forwarding the still picture one by one from the currently reproduced still picture to the next one, a mode of reversing the still picture one by one from the currently reproduced still picture to the previous one, or may be embodied in a mode of directly selecting any desired still picture in spite of the currently reproduced still picture or the reproduction sequence of the still picture. Any mode is applicable to the information reproducing apparatus 10.

In the above discussion, the user selects the still picture during the reproduction. Nevertheless, almost the same operation is embodied, also in the case that the user selects the still picture while the reproduction is paused or not performed. That is, while the reproduction is not performed, if the user selects the desired still picture, for example, the still picture corresponding to the still picture information unit D, and then inputs a command to start the reproduction, the still picture information unit D and the audio information M are reproduced from the reproduction position corresponding to the reproduction time point T3, as shown in FIG. 4.

Thus, according to the information reproducing apparatus of the present embodiment, even in the case that the reproduction time points of multiple still picture information units are predetermined in the slide show reproduction, the selection and reproduction of the still picture information are possible, on the basis of the user's selection command and the like. Thereby, the user can forward the desired still picture one by one, or can reverse the still picture one by one to watch the missed still picture, or can watch the desired still picture by directly specifying the number of the desired still picture.

Next, various aspects of the information reproducing apparatus 10 of the present embodiment will be discussed.

In the above-mentioned information reproducing apparatus 10, the controlling device 14 may be designed in such a manner that the controlling device 14 controls the audio reproducing device and the still picture reproducing device so as to reproduce the audio information and the one still picture information unit selected through the selecting device 13 from the reproduction position corresponding to the reproduction start time point of the one still picture information unit selected through the selecting device.

That is, as mentioned above, in the case that the controlling device 14 controls the reproduction of the audio information and one still picture information unit, on the basis of the one still picture information unit selected through the selecting device 13, the reproduction time point of one still picture information unit may be any time point during the reproduction of the one still picture information unit. If the reproduction time point of one unit of still picture is the reproduction start time point of the one still picture information unit, however, the reproduction of one unit of still picture, selected by the user, from the reproduction start time point of the one still picture information unit is possible, and the reproduction of one still picture information unit desired by the user is possible for a predetermined period.

Alternatively, the selecting device 13 may be designed to include a command input device for inputting a command to select one still picture information unit to be reproduced next to the currently reproduced still picture information unit.

Thereby, the user can forward the desired still picture one by one, by operating the command input device.

Alternatively, the selecting device 13 may be designed to include a command input device for inputting a command to select one still picture information unit to be reproduced prior to the currently reproduced still picture information unit.

Thereby, the user can reverse the multiple still picture information units one by one to watch the missed still picture, by operating the command input device.

Alternatively, the selecting device 13 may be designed to include a command input device for inputting a command to select desired one still picture information unit from among multiple still picture information units.

Thereby, the user can select directly and watch the desired still picture, by operating the command input device.

Incidentally, the above-mentioned embodiments may be tangibly embodied in a specified device integrated within a hardware, or may be tangibly embodied in making a computer read a program.

### EXAMPLES

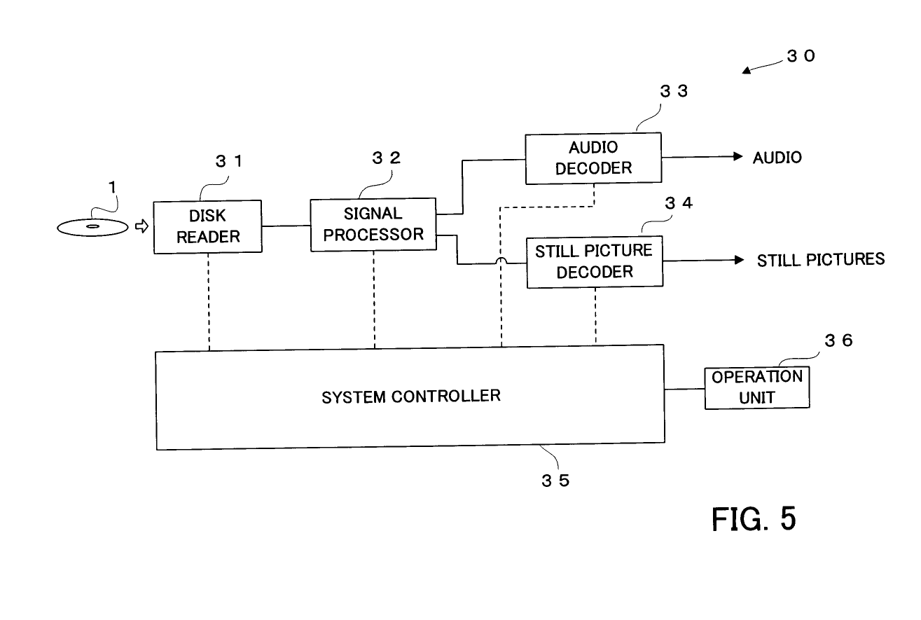

Hereinbelow, the Examples of the present invention will be discussed, referring to FIG. 5 to FIG. 8. In the following Examples, the information reproducing apparatus of the present invention is applied to a DVD audio player.

Firstly, a construction of a DVD audio player according to an Example of the present invention will be discussed. FIG. 5 illustrates the construction of the DVD audio player according to the Example. As shown in FIG. 5, the DVD audio player 30 is an information reproducing apparatus for reproducing audio information, still picture information units and the like, which are recorded in a DVD 1. The audio information may be information obtained by encoding a unit of music, and the still picture information unit is information obtained by encoding a still picture. The DVD audio player 30 has a function to perform a so-called “slide show reproduction”, for reproducing the still picture information unit during the reproduction of the audio information.

The DVD audio player 30 is provided with a disk reader 31, a signal processor 32, an audio decoder 33, a still picture decoder 34, a system controller 35 and an operation unit 36.

The disk reader 31 is provided with an optical pickup for irradiating a light beam onto a recording surface of the DVD 1 and receiving the reflection light, a spindle motor for rotating the DVD 1, and a servo control mechanism for controlling the irradiation spot of the light beam and the rotation of the spindle motor or the like (all of which is not shown), and so on. The disk reader 31 reads a signal including the audio information and the still picture information units, which are recorded in the DVD 1 and outputs the read signal to the signal processor 32.

The signal processor 32 is provided with a decoding circuit or the like. The signal processor 32 decodes the signal outputted from the disk reader 31 and extracts the audio information, the still picture information units and control information for controlling the reproduction of these kinds of information, and so on. Then, the audio information and the still picture information units are supplied to the audio decoder 33 and the still picture decoder 34, respectively.

The audio decoder 33 is a circuit for decoding the audio information. The audio signal decoded at the audio decoder 33 is supplied to the speaker or the like via a digital-analog converter for example.

The still picture decoder 34 is a circuit for decoding the still picture information units. The still picture signal decoded at the still picture decoder 34 is supplied to a monitor such as an LCD (Liquid Crystal Display), a PDP (Plasma Display Panel) or the like.

The system controller 35 is provided with a memory circuit and a processing circuit, such as a CPU (Central Processing Unit), ROM (Read Only Memory), RAM (Random Access Memory) or the like. The system controller 35 performs a processing of selecting the still picture, a reproduction control and an overall control of the DVD audio player 30.

The operation unit 36 is provided with a switch panel, a remote controller or the like. The operation unit 36 is a user interface allowing the user to input a command to turn on/off the power, start or resume the reproduction, stop the reproduction, select the group and track, and the like into the DVD audio player 30.

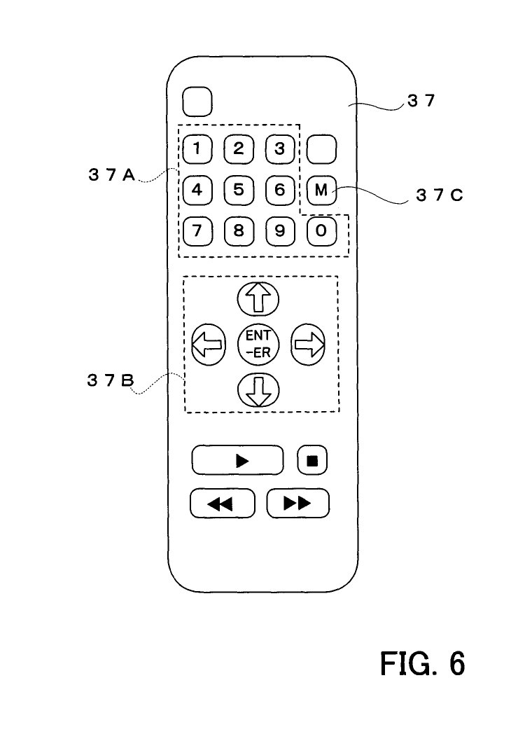

Herein, FIG. 6 illustrates a panel surface of the remote controller 37 as a part of the operation unit 36. As shown in FIG. 6, the remote controller 37 is provided with a numeral button portion 37A including multiple numeral buttons, an arrow button portion 37B including multiple arrow buttons and an enter button, and a still picture selecting mode button 37C.

Next, the audio information, the still picture information, and the control information for controlling the reproduction of these kinds of information will be discussed.

Into the DVD 1, according to a DVD audio standard, the audio information, the still picture information units and the control information for controlling the reproduction these kinds of information are recorded. The audio information has a hierarchical structure mainly made of groups, audio titles and tracks. The group is made of some audio titles. The audio title is made of a program chain including some programs. The track corresponds to a program defined by the program chain.

The user can specify the group and the track, when reproducing the DVD 1. If the user specifies a group and further specifies a track in the group, an AOB (Audio Object) and an ASVOB (Audio Still Video Object) associated with the track (program) on the basis of the program chain information is reproduced. On the other hand, the AOB is made of one or more cells. The AOB corresponds to the audio information, and the ASVOB corresponds to the still picture information unit(s).

On the other hand, according to the DVD standard, there are various ways of reproducing the still picture information units during the reproduction of the audio information. Such a way of reproducing is of selected and determined by the maker who supplies the audio information and the still picture information units. The maker selects a way of reproducing the still picture information units and records the selected way into the DVD 1 as the control information. Thereby, the DVD audio player 30 reads the control information and reproduces the still picture information units in accordance with the way recorded as the control information.

One of ways of reproducing the still picture information units is the slide show reproduction. The slide show reproduction is a way of reproducing (displaying) multiple still pictures one by one at the predetermined time interval. In the present Example, the maker of the information recorded in the DVD 1 selects the slide show reproduction as a way of reproducing the still picture information units, and the control information for indicating it is recorded in the DVD 1.

In order to perform the slide show reproduction of the multiple still pictures, the DVD 1 includes display list information (reproduction control information) and multiple still picture information units. The still picture information units correspond to the multiple still pictures respectively. The display list information includes information indicating the reproduction start time for each still picture information unit. The display list information can be made and recorded for each track.

Incidentally, the reproduction start time for each of multiple still picture information units included in the display list information is determined by the maker who supplies the audio information and the still picture information units. Therefore, the value of the reproduction start time for each of multiple still picture information units recorded in the DVD 1 is fixed, and the user cannot change the value.

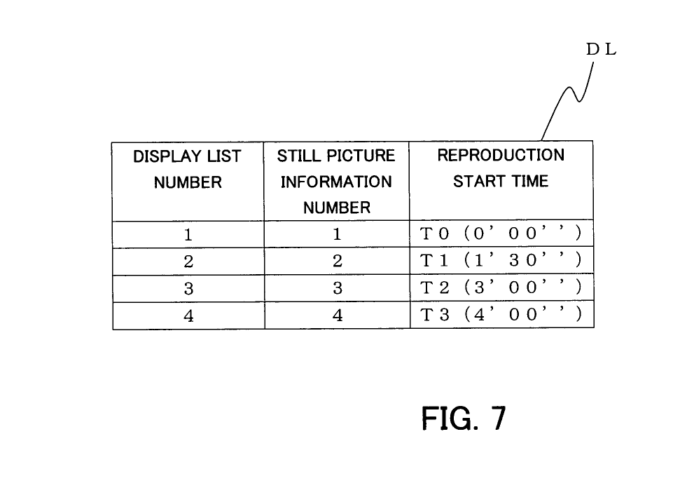

FIG. 7 illustrates an example of the display list information. In the present Example, for the sake of convenience, a simple specific example is presented, that is, the display list information DL as shown in FIG. 7 is prepared for the track #1 in the group #1 and recorded in the DVD 1.

As shown in FIG. 7, four display lists relating to the still picture information to be reproduced (displayed) during the reproduction of the track #1 are described in the display list information DL in the reproduction order. Each display list is made of a display list number (a first column in FIG. 7), a still picture information unit number (a second column in FIG. 7) and a reproduction start time (a third column in FIG. 7).

The display list number is for indicating the reproduction order of each display list (the reproduction order of still picture information unit designated in each display list) and for identifying individual display list. The still picture information unit number is a number for indicating the still picture information to be reproduced during the reproduction of the track #1. The reproduction start time is a reproduction start time of each still picture information to be reproduced during the reproduction of the track #1.

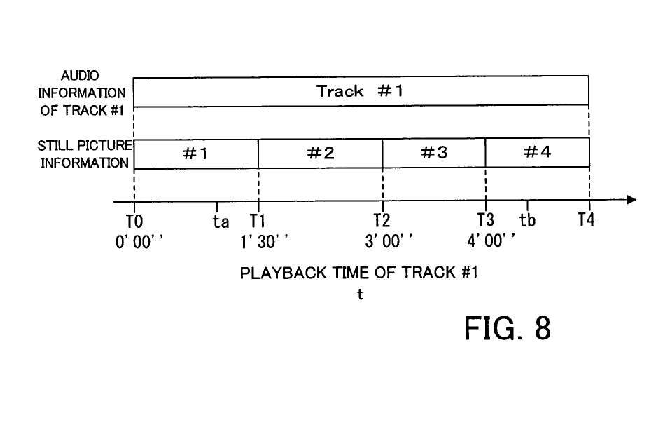

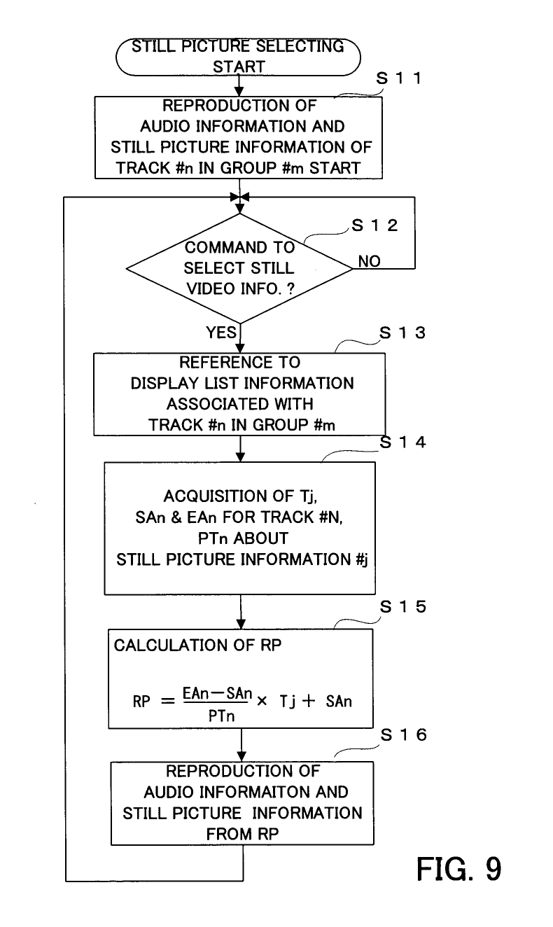

FIG. 8 illustrates temporal relationship between the audio information associated with the track #1 and the still picture information units #1 to #4 associated with the track #1, during the reproduction of the track #1. When the track #1 is reproduced, the audio information and the still picture information units associated with the track #1 are reproduced as shown in FIG. 8.

That is, a lateral axis in FIG. 8 is representative of a reproduction time t. When the reproduction time t is T0 (T0 is 0′00″ in FIG. 8), the reproduction of the audio information is started. When the reproduction time t is T4, the reproduction of the audio information is terminated. On the other hand, when the reproduction time t is T0, the reproduction of the still picture information unit #1 is started simultaneously with the start of the reproduction of the audio information. When the reproduction time t is T1 (1′30″), the still picture information unit to be reproduced is switched from the still picture information unit #1 to the still picture information unit #2. Further, when the reproduction time t is T2 (3′00″), the still picture information unit to be reproduced is switched from the still picture information unit #2 to the still picture information unit #3. Similarly, when the reproduction time t is T3 (4′00″), the still picture information unit to be reproduced is switched from the still picture information unit #3 to the still picture information unit #4. Finally, when the reproduction t arrives at T4, the reproduction of the still picture information unit #4 is terminated simultaneously with the termination of the reproduction of the audio information.

Next, the reproduction control and the processing of selecting the still picture in the DVD audio player 30 will be discussed, referring to FIG. 9.

If the user loads the DVD 1 into the DVD audio player and inputs a command to reproduce the track #m in the group #n for example, by operating the remote controller 37, then the DVD audio player 30 starts the reproduction of the audio information and the still picture information associated with the track #m in the group #n recorded in the DVD 1, under control of the system controller 35.

Next, the system controller 35 executes the processing of selecting the still picture. FIG. 9 illustrates the processing of selecting the still picture. The processing of selecting the still picture is a processing of performing the change, selection and reproduction of the still picture in the slide show reproduction, in accordance with the user's selection command.

As shown in FIG. 9, the system controller 35 determines whether or not the command to select the still picture information is inputted (step S12), after starting the reproduction of the audio information and the still picture information associated with the track #n in the group #m (step S11).

For example, if the user inputs a command to select the still picture information unit #j through the operation of the remote controller 37, before the reproduction start time of the still picture information unit #j arrives, in order to watch the still picture information unit #j to be reproduced next to the currently reproduced still picture information unit #i, the system controller 35 receives the user's command (step S12: YES).

Next, the system controller 35 refers to the display list information associated with the currently reproduced the track #n in the group #m (step S13).

Then, the reproduction start time Tj of the still picture information unit #j is obtained from the display list information. Further, a start address SAn of the first cell of the audio information associated with the track #n, an end address EAn of the last cell of the audio information associated with the track #n, and a total reproduction time PTn of the track #n are obtained (step S14). Incidentally, these kinds of information are recorded in the DVD 1 as the control information (may recorded into the RAM in the system controller 35 in the course of the reproduction).

Then, the reproduction position RP is obtained by performing an arithmetical operation, on the basis of the following mathematical formula.

RP=(EAn−SAn)Tj/PTn+SAn

Next, the system controller 35 controls the audio decoder 33, the still picture decoder 34 and the like so as to reproduce the audio information and the still picture information unit #j from the reproduction position RP. Thereby, the audio information and the still picture information unit #j of the track #n in the group #m is reproduced from the reproduction position RP corresponding to the reproduction start time #j.

Next, the specific operation and effect of the above-mentioned processing of selecting the still picture will be specifically discussed, referring to FIG. 8.

As shown in FIG. 8, the user loads the DVD 1 into the DVD audio player 30 and inputs a command to start the reproduction of the track #1 in the group #1 through the operation of the remote controller 37, the DVD audio player 30 starts the reproduction of the audio information associated with the track #1 in the group #1 (t=T0=0). At the same time, the still picture information unit #1 associated with the track #1 in the group #1 is reproduced.

Then, for example, assume that the user inputs a command to select the still picture information unit #2 next to the presently reproduced still picture information unit #1, by pressing the still picture selecting button 37C of the remote controller 37 as shown in FIG. 6 and then pressing once the right arrow button in the arrow button portion 37B, at a time point “ta”(e.g. 1′00″) before the reproduction time t arrives at a time point T1. Then, the still picture information unit #2 is immediately reproduced from the position corresponding to the reproduction start time point T1 of the still picture information unit #2 through the above-mentioned processing of selecting the still picture, while the audio information associated with the track #1 is reproduced from the reproduction position. Incidentally, as a result, the audio information corresponding to a range from the time point “ta” to the time point T1 is skipped.

On the other hand, assume that the user presses twice the right arrow button in the arrow button portion 37 to select the still picture information unit #3 at the time point “ta”. Then, the still picture information unit #3 is immediately reproduced from the position corresponding to the reproduction start time point T2 of the still picture information unit #3 through the above-mentioned processing of selecting the still picture, while the audio information associated with the track #1 is reproduced from the reproduction position.

Alternatively, the user can select the desired still picture information directly through the operation of the numeral button portion 37A of the remote controller 37 at the time point “ta”. For example, if the user pressed a numeral button “3” at the time point “ta”, the still picture information unit #3 and the audio information is reproduced directly from the reproduction position corresponding to the reproduction start time point T2 of the still picture information unit #3.

On the other hand, assume that the reproduction of the track #1 in the group #1 has passed 4 minutes without a command to select the still picture. At this time, the still picture information unit #4 is reproduced, as shown in FIG. 8. Then, if the user inputs a command to select the still picture information unit #3 prior to the presently reproduced still picture information unit #4, by pressing the still picture selecting mode button 37C of the remote controller 37 and then pressing once a left arrow button in the arrow button portion 37B, at a time point “tb” before the reproduction of the track #1 is completed, then the still picture information unit #3 is reproduced directly from the reproduction position corresponding to the reproduction time point T2 of the still picture information unit #3 through the above-mentioned processing of selecting the still picture, while the audio information associated with the track #1 is reproduced from the reproduction position.

On the other hand, if the user presses twice the left arrow button in the arrow button portion 37 to select the still picture information unit #2 at the time point “tb”, the still picture information unit #2 is reproduced directly from the reproduction position corresponding to the reproduction start time point T1 of the still picture information unit #2 through the above-mentioned processing of selecting the still picture, while the audio information associated with the track #1 is reproduced from the reproduction position.

Alternatively, if the user presses a numeral button “2” in the numeral button portion 37A at the time point “tb”, the still picture information unit #2 and the audio information is reproduced directly from the reproduction position corresponding to the reproduction start time point T1 of the still picture information unit #2.

Incidentally, a situation that a still picture is selected during the reproduction of the audio information and another still picture has been discussed above as a situation of performing the still picture information processing, the still picture information processing may be performed during a period that the reproduction is not performed. That is, if the user selects the group #m, the track #n and the still picture information unit #j through the operation of the remote controller 37 and then inputs a command to start or resume the reproduction during the period that the reproduction is not performed, the group #m, the track #n and the still picture information unit #j is reproduced immediately, while the audio information associated with the track #n is reproduced from the reproduction start time point Tj of the still picture information unit #j.

Thus, according to the DVD audio player 30 of the present Example, owing to such a construction that if the user inputs a command to select the still picture, the reproduction position of the track is determined on the basis of the reproduction start time point of the selected still picture information unit, and the selected still picture information unit and the audio information is reproduced immediately from the reproduction position, it is possible to select and reproduce the still picture in accordance with the user's selecting command, even in the case that each reproduction start time point of the multiple still picture information units is predetermined and fixed for the slide show reproduction.

Thereby, the user can forward the desired still picture one by one, or reverse the still picture one by one to watch the missed still picture, otherwise can watch the desired still picture by directly specifying the number of the desired still picture information.

It is noted that the way of calculating the reproduction position in the above-mentioned processing of selecting the still picture is presented as only an example. Any other calculation way is applicable, insofar as the reproduction position of the track can be identified from the reproduction time point of the selected still picture information. Furthermore, a way of selecting the still picture information is not limited to the above-mentioned Embodiment or Example.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-252805 filed on Aug. 30, 2002 including the specification, claims, drawings and summary is incorporated herein by reference in its entirety.

What is claimed is:

1. An information reproducing apparatus for reproducing audio information and a plurality of still picture information units on the basis of reproduction control information for indicating reproduction time points of the respective plurality of still picture information during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction time points;
a selecting device for selecting a still picture information unit among the plurality of still picture information units; and
a controlling device for controlling the audio reproducing device and the still picture reproducing device so as to reproduce the audio information and the selected still picture information unit from a reproduction position corresponding to a reproduction time point of the selected still picture information unit.

2. The information reproducing apparatus according to claim 1, wherein the controlling device controls the audio reproducing device and the still picture reproducing device so as to reproduce the audio information and the selected still picture information unit from a reproduction position corresponding to a reproduction start time point of the selected still picture information unit.

3. The information reproducing apparatus according to claim 1, wherein the selecting device includes a command input device for inputting a command to select a still picture information unit to be reproduced after a still picture information unit that is being reproduced at the present time.

4. The information reproducing apparatus according to claim 1, wherein the selecting device includes a command input device for inputting a command to select a still picture information unit to be reproduced before a still picture information unit that is being reproduced at the present time.

5. The information reproducing apparatus according to claim 1, wherein the selecting device includes a command input device for inputting a command to select a desired still picture information unit from among the plurality of still picture information units.

6. A computer program product in a computer-readable medium for tangibly embodying a program of instructions executable by a computer to make the computer function as an information reproducing apparatus for reproducing audio information and a plurality of still picture information units on the basis of reproduction control information for indicating reproduction time points of the respective plurality of still picture information during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction time points;
a selecting device for selecting a still picture information unit among the plurality of still picture information units; and
a controlling device for controlling the audio reproducing device and the still picture reproducing device so as to reproduce the audio information and the selected still picture information unit from a reproduction position corresponding to a reproduction time point of the selected still picture information unit.

7. An information reproducing method of reproducing audio information and a plurality of still picture information units on the basis of reproduction control information for indicating reproduction time points of the respective plurality of still picture information during a reproduction of the audio information, the information reproducing method comprising:
an audio reproducing process of reproducing the audio information;
a still picture reproducing process of reproducing the plurality of still picture information units in sequence by switching the plurality of still picture information units one after another according to the reproduction time points;
a selecting process of selecting a still picture information unit among the plurality of still picture information units; and
a controlling process of controlling the reproduction of the audio information in the audio reproducing process and the reproduction of the plurality of still picture information units in the still picture reproducing process so as to reproduce the audio information and the selected still picture information unit from a reproduction position corresponding to a reproduction time point of the selected still picture information unit.
